(19) United States
(12) Patent Application Publication
(10) Pub. No.: US 2023/0306520 A1
(43) Pub. Date: Sep. 28, 2023

(54) SYSTEMS AND METHODS FOR RESOURCE ALLOCATION IN A DYNAMIC SYSTEM

(71) Applicant: BlackRock, Inc., New York, NY (US)

(72) Inventors: Misha van Beek, New York, NY (US); Thomas Booker, New York, NY (US)

(21) Appl. No.: 18/187,586

(22) Filed: Mar. 21, 2023

Related U.S. Application Data
(60) Provisional application No. 63/322,482, filed on Mar. 22, 2022.
(60) Provisional application No. 63/357,849, filed on Jul. 1, 2022.

(51) Int. Cl. G06Q 40/06

(52) U.S. Cl. CPC G06Q 40/06

(57) ABSTRACT

Embodiments described herein provide a model predictive control (MPC) method in a dynamic control system for strategic asset allocation (SAA) with illiquid asset classes. For example, the multi-period optimization-based MPC method for constructing portfolios with both liquid and illiquid alternative assets incorporates random intensities with the classic linear model of the illiquid asset's calls and distributions to formulate a multi-period optimization problem to perform strategic asset allocation with liquid and illiquid assets. The multi-period optimization problem uses homogeneous risk constraints to account for growth in the multi-period planning, and liquidity/insolvency constraints to ensure calls are covered with high probability.

### CROSS REFERENCE(S)

The present disclosure is a nonprovisional of and claims priority under 35 U.S.C. 119 to U.S. provisional application No. 63/322,482, filed on Mar. 22, 2022, which is hereby expressly incorporated by reference herein in its entirety.

### TECHNICAL FIELD

The present disclosure relates generally to optimal control in a dynamic system, and more specifically, to system and methods for resource allocation in a dynamic system.

### BACKGROUND

An illiquid asset is an asset that cannot be easily bought or sold in the market without significantly affecting its price. Illiquid assets are usually characterized by low trading volume and limited market participation, which can make it difficult to find a buyer or seller for the asset. Examples of illiquid assets include real estate, private equity, venture capital, hedge funds, art, and collectibles. These assets often require a long-term investment horizon, and it can be challenging to convert them into cash quickly. The lack of market transparency and the difficulty of valuing illiquid assets can also create challenges for investors and lead to information asymmetry between buyers and sellers. Illiquid assets are commonly held by institutional investors, such as pension funds, endowments, and sovereign wealth funds, who have a long-term investment horizon and a higher risk tolerance. Retail investors may also have access to some illiquid assets through alternative investment vehicles, such as private equity funds or real estate investment trusts (REITs).

For example, an investment process is a dynamically evolving process based on various control events, such as making an investment decision, constructing an investment portfolio, executing a trade order, and/or the like, is often guided by a portfolio manager, or implemented as an automated process, or some combination. Strategic Asset Allocation (SAA) is the problem of deciding how much to allocate to each of a (usually single digit) number of broad asset classes. In particular, for illiquid alternative asset classes (such as real estate, valuable art work, and/or the like). One challenge in portfolio construction with illiquid asset classes is that investors often do not have direct control over our positions. Instead investors can only make commitments; the position builds up over time as capital calls come in, and reduces over time as distributions occur, neither of which the investor has direct control over. The effect on positions of investor commitments is subject to a delay, typically of a few years, and is also unknown or stochastic.

Therefore, there is a need to find an efficient mechanism to improve strategic asset allocation with illiquid alternatives.

### BRIEF DESCRIPTION OF THE DRAWINGS

FIG. 1 is a simplified diagram illustrating an example of timeline-based stochastic dynamics for an illiquid asset, according to some embodiments described herein.

FIG. 2 is a simplified diagram illustrating a server interacting with various entities to generate an illiquid asset commitment plan over time described in FIG. 1, according to some embodiments described herein.

FIG. 3 is a block diagram 200 of a networked system suitable for implementing the processes described in FIG. 2 and other embodiments described herein, according to an embodiment.

FIG. 4 is a simplified diagram illustrating example aspects of open loop commitment control implemented by the commitment optimization module, according to some embodiments described herein.

FIG. 5 is a simplified diagram illustrating example aspects of close loop commitment control implemented by the commitment optimization module, according to some embodiments described herein.

FIG. 6 shows the example results by executing the obtained sequence of planned commitments using the open-loop method under random calls and distributions for 100 simulated realizations.

FIG. 7 shows the example results by executing the obtained sequence of planned commitments using the close-loop method under random calls and distributions for 100 simulated realizations.

FIG. 8 provides a simplified block diagram illustrating example aspects of strategic asset allocation with full illiquid dynamics as described in relation to FIGS. 4-5, according to embodiment described herein.

FIGS. 9-11 are an example risk-return trade-off plot for the strategic asset allocation shown in FIG. 8.

FIG. 12 is an example logic flow diagram illustrating a method of generating a commitment plan for a portfolio comprising at least one illiquid asset class shown in FIGS. 1-11, according to some embodiments described herein.

FIG. 13 is a simplified diagram illustrating a computing device used to implement the server and/or other entities described in FIGS. 1-12, according to some embodiments described herein.

Appendix I provides additional embodiments of resource allocation among illiquid asset classes and liquid asset classes.

In the figures and appendices, elements having the same designations have the same or similar functions.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

A financial server, such as one associated with BlackRock®, etc., may receive financial data relating to the market and an investor to construct portfolios which mix liquid and illiquid assets, especially illiquid alternative investments, for the investor. Specifically, the financial server may perform strategic asset allocation to asset classes that include illiquid alternative assets, as well as more liquid asset classes. To process the illiquid asset alternative, several challenges arise. First, the illiquid positions can only be augmented by making capital commitments. Moreover, these commitments only indirectly affect the illiquid position through uncertain and delayed capital calls, which investors have no direct control over. A further challenge is the solvency requirement: investors should be able to fund the capital calls from their liquid positions with very high probability. A simple strategy to guarantee coverage of capital calls is to keep an amount equal to the uncalled capital commitments in cash. However, this creates significant cash drag, since this cash could be invested in higher returning liquid assets.

In view of the various existing issues in strategic asset allocation to asset classes that include illiquid alternative assets, embodiments described herein provide a model predictive control (MPC) method in a dynamic control system for strategic asset allocation (SAA) with illiquid asset classes. For example, the multi-period optimization-based MPC method for constructing portfolios with both liquid and illiquid alternative assets incorporates random intensities with the classic linear model of the illiquid asset's calls and distributions to formulate a multi-period optimization problem to perform strategic asset allocation with liquid and illiquid assets. The multi-period optimization problem uses homogeneous risk constraints to account for growth in the multi-period planning, and liquidity/insolvency constraints to ensure calls are covered with high probability.

In this way, multi-period optimization-based policies for constructing portfolios with both liquid and illiquid alternative assets may be formulated as a convex optimization, which may be efficiently solved by a convex optimization procedure

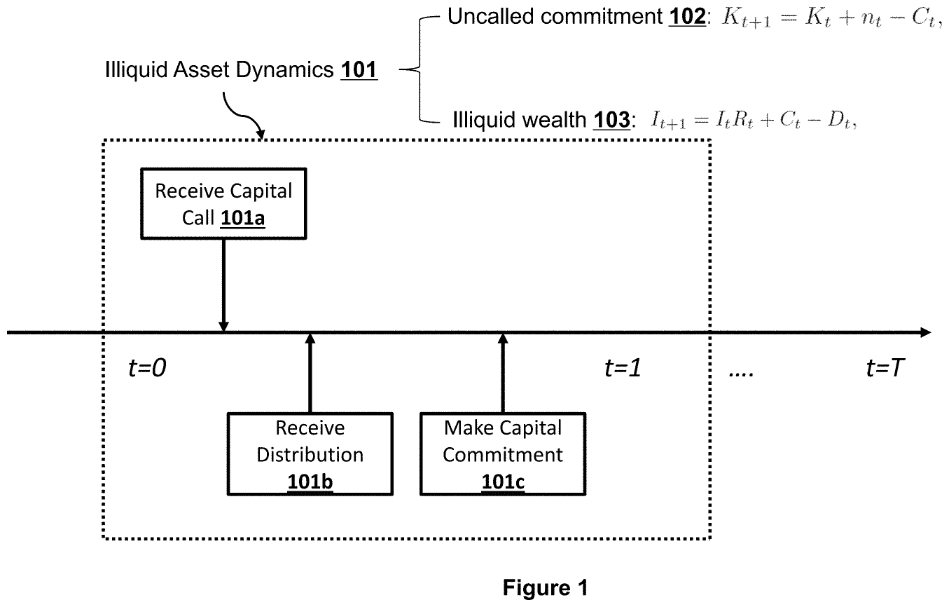

FIG. 1 is a simplified diagram illustrating an example of timeline-based stochastic dynamics for an illiquid asset, according to some embodiments described herein. FIG. 1 shows a discrete-time setting, with periods denoted by t=1; 2; 3, . . . , which could represent months, quarters, years, or any other period. For example, the dynamics 101 of an illiquid asset involves the following quantities, all denominated in dollars: at each time t, the portfolio may receive capital call 101a Cₜ≥0; receive distribution 101b Dₜ≥0 and make a new capital commitment 101c nₜ≥0. As a result, Iₜ≥0 is the illiquid wealth 103 (or position in or NAV of the illiquid asset) at period t; and Kₜ≥0 the total uncalled commitments 102 at period t.

Thus, at each time period t, a new capital commitment 101c nₜ≥0 may be made, which may be controlled by the SAA system. The new capital call 101a Cₜ≥0 and distribution 101b Dₜ≥0 may not be controlled by the SAA system. The uncalled commitment 102 in period t+1 is evolved as:

Kₜ₊₁=Kₜ+nₜ−Cₜ,

and the illiquid wealth 103 in period t+1 is:

Iₜ₊₁=IₜRₜ+Cₜ−Dₜ,

where Rₜ≥0 is a random total return on the illiquid asset.

In one embodiment, the calls 101a may be random fractions of Kₜ, Pₜ and nₜ:

Cₜ=λₜ⁰nₜ+λₜ¹Kₜ,

where λₜ⁰∈[0,1] is the random immediate commitment call intensity and λₜ¹∈[0,1] is the random existing commitment call intensity. Similarly, the distributions 101b may be computed as:

Dₜ=IₜRₜδₜ,

where δₜ∈[0,1] is the random distribution intensity.

In one embodiment, the random variables (Rₜ,λₜ⁰,λₜ¹,δₜ)∈R×[0,1]³ are I.I.D., i.e., independent across time and identically distributed. But for fixed period t, the components Rₜ, λₜ⁰, λₜ¹, δₜ may not be independent. These random variables may be unknown when the current commitment nₜ is chosen. The current commitment can depend on anything known at the beginning of period t (including for example past values of returns and intensities), but the current period return and intensities are independent of the commitment.

Therefore, the illiquid dynamics 101 may be expressed as a linear system with random dynamics and input matrices. With state xₜ=(Iₜ, Rₜ)∈R² and the control or input uₜ=nₜ∈R, the dynamics are given by

$${x}_{t + 1} = {A}_{t} {x}_{t} + {B}_{t} {u}_{t} , \qquad ( 1 )$$

$$where$$

$${A}_{t} = [ \begin{matrix}{R}_{t} ( 1 - {δ}_{t} ) & {λ}_{t}^{1} \\ 0 & 1 - {λ}_{t}^{1}\end{matrix} ] ,$$

$${B}_{t} = [ \begin{matrix}{λ}_{t}^{0} \\ 1 - {λ}_{t}^{0}\end{matrix} ] .$$

With output yₜ=(Iₜ, Kₜ, Cₜ, Dₜ)∈R⁴, the output can be expressed as:

$${y}_{t + 1} = {F}_{t} {x}_{t} + {G}_{t} {u}_{t} , \qquad ( 2 )$$

$$where$$

$${F}_{t} = [ \begin{matrix}1 & 0 \\ 0 & 1 \\ 0 & {λ}_{t}^{1} \\ {R}_{t} ( 1 - {δ}_{t} ) & 0\end{matrix} ] ,$$

$${G}_{t} = [ \begin{matrix}0 \\ 0 \\ {λ}_{t}^{0} \\ 0\end{matrix} ] .$$

In one embodiment, when the initial state is known, xₜ [symbol] (Fₜ, Gₜ), since the former depends on the initial state, nₜ, and (F_{τ}, G_{τ}), for τ<t, and these are all independent of (Fₜ, Gₜ).

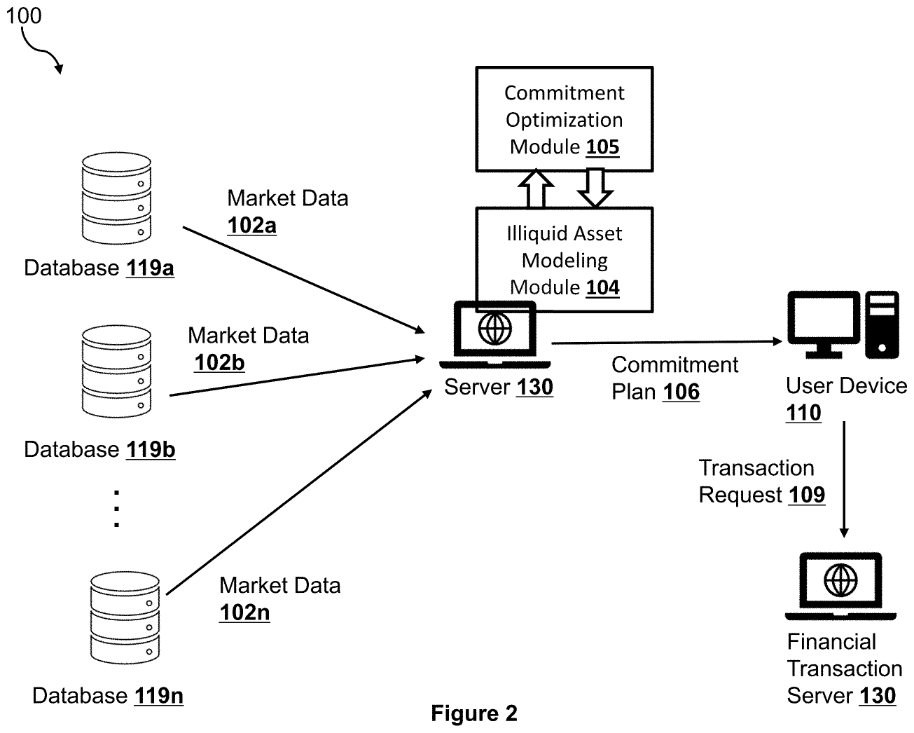

FIG. 2 is a simplified diagram 100 illustrating a server interacting with various entities to generate an illiquid asset commitment plan over time described in FIG. 1, according to some embodiments described herein. Diagram 100 shows a server 130, various databases 119a-n, a user device 110, and/or the like interacting with each other, e.g., via a communication network. In diagram 100, a certain number of databases, 119a-n, are shown for illustrative purposes, while more than such number of databases may be communicative with the server 130.

In one embodiment, the server 130 may receive various account data and/or market data 102a-n from the databases 119a-n. For example, the server 130 may receive the calls and distributions at each time period t, and/or the like.

An illiquid asset modeling module 104 implemented at the server 130 may compute parameters for modeling the stochastic dynamics of the illiquid asset classes. For example, given the illiquid dynamics 101 described in relation to FIG. 1, let x̅ₜ=Exₜ denote the mean of the state, ūₜ=Euₜ denote the mean of the input or control, and ŷₜ=Eyₜ denote the mean of the output, the mean matrices may be computed as:

Ā=EAₜ,B̅=EBₜ,F̅=EFₜ,G̅=EGₜ,

(which do not depend on t). Then:

x̅ₜ₊₁=Āx̅ₜ+B̅ūₜ,y̅ₜ=F̅x̅ₜ+G̅ūₜ, (3)

which states that the mean state and output is described by the same linear dynamical system, with the random matrices replaced with their expectations. The mean dynamics is a time-invariant deterministic linear dynamical system. The computed mean matrices may be fed to the commitment optimization module 105.

In one embodiment, the commitment optimization module 105 may perform convex optimization to choose a sequence of commitments to meet various goals in expectation, based on the model parameters from the illiquid dynamics modeling module 104. For example, consider the task of starting with no illiquid exposure or uncalled commitments, i.e., I₁=0, K₁=0, and choosing a sequence of commitments, nt, t=1, . . . , T. The goal is to reach and maintain an illiquid wealth of I^{tar}, so a primary objective can be computed as the mean-square tracking error:

$$\frac{1}{T + 1} {\sum }_{t = 1}^{T + 1} {( {I}_{t} - {I}^{tar} )}^{2} .$$

In addition, to add a smooth sequence of commitments, a secondary objective term which is the mean square difference in commitments may be computed:

$$\frac{1}{T - 1} {\sum }_{t = 2}^{T} {( {n}_{t} - {n}_{t - 1} )}^{2} ,$$

a maximum allowed per-period commitment, i.e., nₜ≤n^{lim}. It is noted that other constraints and objective terms may be added, and this example is for illustrative purpose only.

In one embodiment, the illiquid asset modeling module 104 may formulate an investment universe consisting of multiple illiquid alternative and liquid assets. For example, the illiquid asset can be extended to a universe of n^{ill} illiquid assets. In this way, the dynamics may be extended from scalars to vectors of dimension n^{ill}:

Kₜ,Iₜ,Cₜ,Dₜ∈Rⁿ^{^{ill}},nₜ∈Rⁿ^{^{ill}},Rₜ^{ill},λₜ¹,λₜ⁰,δₜ∈Rⁿ^{^{ill}}.

Each dynamics vector has its own states for exposure and uncalled commitment, and its own control for its new commitments. The illiquid calls, distributions, and returns are now part of a joint distribution. The illiquid dynamics extend in vectorized form to:

Kₜ₊₁=Kₜ+nₜ−Cₜ,Iₜ₊₁=diag(Rₜ)Iₜ+Cₜ−Dₜ,

with

Cₜ=diag(λₜ⁰)nₜ+diag(λₜ¹)Kₜ,Dₜ=diag(Rₜ)diag(δₜ)Iₜ.

Here the return, call, and distribution dynamics here are separable across the illiquid assets, the underling random variables ((Rₜ)ⱼ,(λₜ⁰),(λₜ¹),(δₜ)ⱼ) can be modeled jointly. It is generally assumed that these random variables are independent across time.

For a set of n^{liql} liquid asset classes, these assets may be bought or sold at will at each period; they suffer none of the complex dynamics of the illiquid assets. A new state, Lt, is defined as the (total) liquid wealth at period t. In addition to new commitments for each illiquid asset, at each time t the system now controls how the liquid wealth is allocated in each period, as well as how much outside cash to inject into our liquid wealth. Thus, the additional quantities to control include:
hₜ≥0 (∈Rⁿ^{^{liq}}) is the allocation in dollars invested in liquid at a period t
sₜ≥0 (∈R) is the outside cash injected at period t
   At the beginning of period t, the liquid wealth in liquid assets is allocated. This corresponds to the constraint Lₜ=1^{T}hₜ. Multiplicative liquid returns (Rₜ^{liq})ⱼ∈R on liquid asset j, yielding total return hₜ^{T}Rₜ^{liq}. Capital calls may then be paid from and receive distributions to liquid wealth, for all illiquid assets. This corresponds to a net increase in liquid wealth given by −1^{T}Cₜ+1^{T}Dₜ. Lastly, if at this stage the liquid wealth is negative, outside cash se is added to at least bring our liquid wealth to zero. Compactly, the liquid dynamics are:

Lₜ₊₁=hₜ^{T}Rₜ^{liq}−1^{T}Cₜ+1Dₜ+sₜ,

with constraints

hₜ,nₜ,sₜ≥0,Lₜ≥0,Lₜ=1^{T}hₜ.

Thus, the joint illiquid and liquid asset dynamics can be represented as a stochastic linear system. Let xₜ=(Lₜ, Iₜ, Kₜ)∈R¹⁺²ⁿ^{^{ill}} be the state vector. The control variable is uₜ=(hₜ, nₜ, sₜ)∈R¹⁺ⁿ^{^{ill}}⁺ⁿ^{^{liq}}. Then the A, B transition matrix may be computed as:

$${A}_{t} = [ \begin{matrix}0 & {( {δ}_{t} ◦ {R}_{t}^{ill} )}^{T} & - λ \text{?} \\ 0 & diag ( ( 1 - {δ}_{t} ) {R}_{t}^{ill} & diag ( λ \text{?} ) \\ 0 & diag ( 0 ) & diag ( 1 - λ \text{?} )\end{matrix} ] , \qquad ( 10 )$$

$${B}_{t} = [ \begin{matrix}{R}_{t}^{{liq}^{T}} & - {λ}_{t}^{{0}^{T}} & 1 \\ {0}^{T} & diag ( {λ}_{t}^{0} ) & 0 \\ {0}^{T} & diag ( 1 - {λ}_{t}^{0} ) & 0\end{matrix} ] .$$

$$\text{?} \text{indicates text missing or illegible when filed}$$

Then the random linear dynamics with multiple illiquids and liquids are:

xₜ₊₁=Aₜxₜ+Bₜuₜ,

with constraints

hₜ,nₜ,sₜ≥0,Lₜ≥0,Lₜ=1^{T}hₜ.

The presence of the outside cash control sₜ implies that a feasible control exists for any feasible value of the states, since sₜ prevents the liquid wealth from ever being negative. Then mean system matrices can be similarly computed as:

Ā=EAₜ,B̅=EBₜ,

and recover the same mean dynamics:

x̅ₜ₊₁=Āx̅ₜ+B̅ūₜ. (11)

Previous generative model specified in Eq. (6) and (7) can be expanded to include liquid returns:

$${z}_{t} = [ \begin{matrix}{z}_{t}^{int} \\ {z}_{t}^{ret}\end{matrix} ] \sim 𝒩 ( μ , Σ ) ∈ {R}^{3 {n}^{m} + {n}^{liq}} , \qquad ( 12 )$$

$$μ = [ \begin{matrix}{μ}^{int} \\ {μ}^{ret}\end{matrix} ] ,$$

$$Σ = [ \begin{matrix}{Σ}^{int} & {Σ}_{12} \\ {Σ}_{21} & {Σ}^{ret}\end{matrix} ] .$$

The delayed and immediate call intensities can be computed as:

$${λ}_{t}^{1} = \frac{1}{1 + {exp ( {z}_{t} )}_{1 : {n}^{m}}} ,$$

$${λ}_{t}^{0} = \frac{1}{2} {λ}_{t}^{1} ,$$

distribution intensities

$${δ}_{t} = \frac{1}{1 + exp + {( {z}_{t} )}_{{n}^{m} + 1 : 2 {n}^{m}}} ,$$

and returns

$$[ \begin{matrix}{R}_{t}^{ill} \\ {R}_{t}^{liq}\end{matrix} ] = [ \begin{matrix}{exp ( {z}_{t} )}_{2 {n}^{ill} + 1 : 3 {n}^{{m}^{ill}}} \\ {exp ( {z}_{t} )}_{3 {n}^{ill} ;}\end{matrix} ] .$$

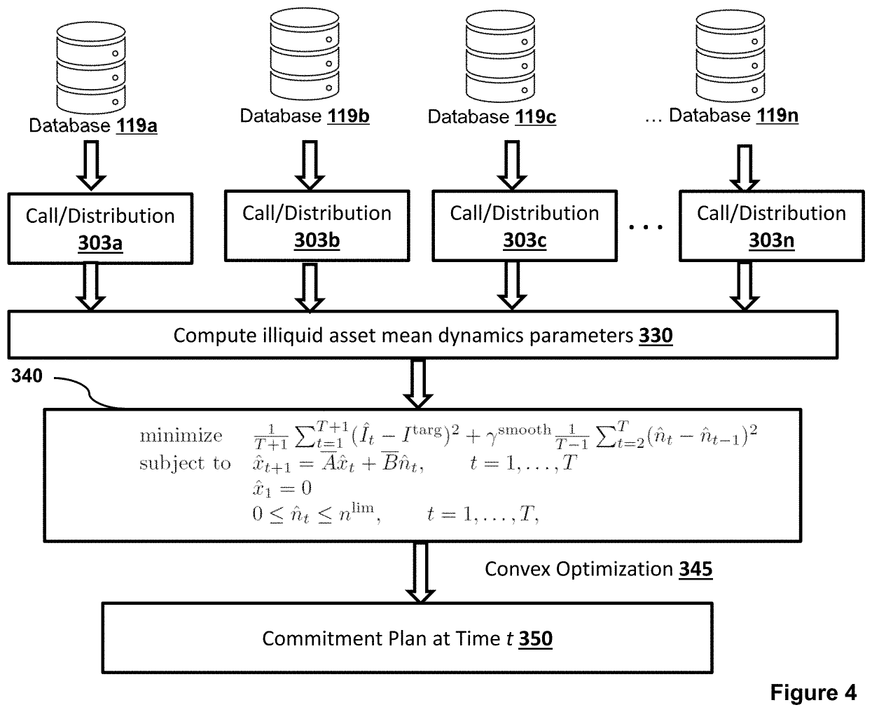

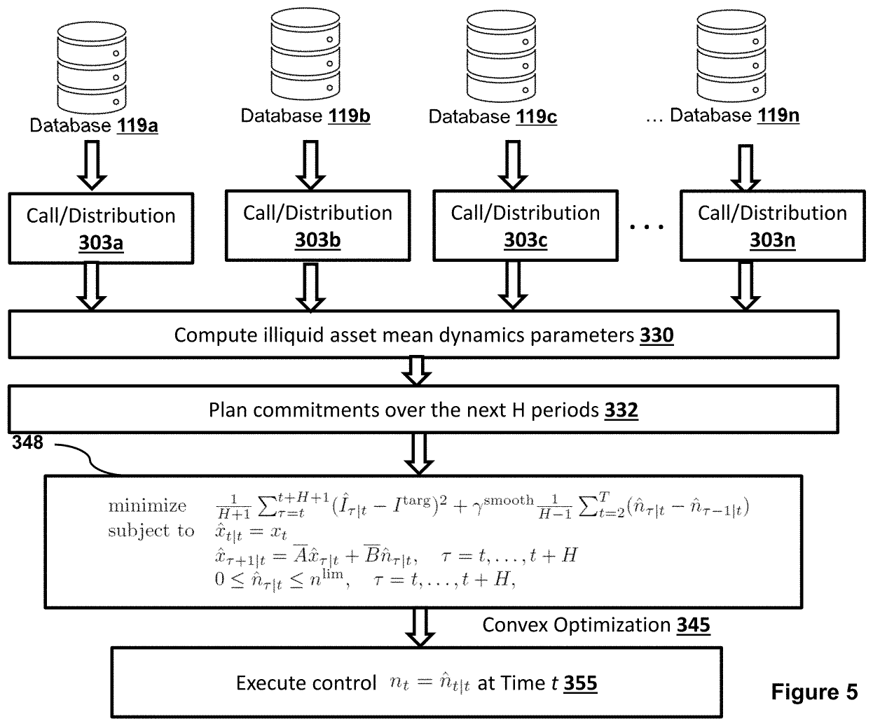

Therefore, the commitment optimization module 105 may receive dynamics parameters from the illiquid asset modeling module 104 and implement an open-loop planning or a close-loop method to determine the commitment plan 106. Specifically, the open-loop planning assumes that state follows its mean trajectory, and a fixed sequence of commitments may be determined, and then executed. The closed-loop method may adapt the commitments based on previously realized returns, capital calls, and distributions, also referred to as model predictive control (MPC). Further details of the open-loop or close-loop optimization solutions may be described in relation to FIGS. 4-5.

In one embodiment, the generated commitment plan 106 may be sent to the user device 110, e.g., via an electronic medium such as electronic mail, instant message, push message, and/or the like. In some implementations, the commitment plan 106 may take a form in an analytics report and presented to the user device 110 via a user interface.

The user device 110 may in turn generate a transaction request 109 according to the commitment plan 106 to a financial transaction server 130, e.g., an adjustment request in the illiquid or liquid asset classes in a portfolio.

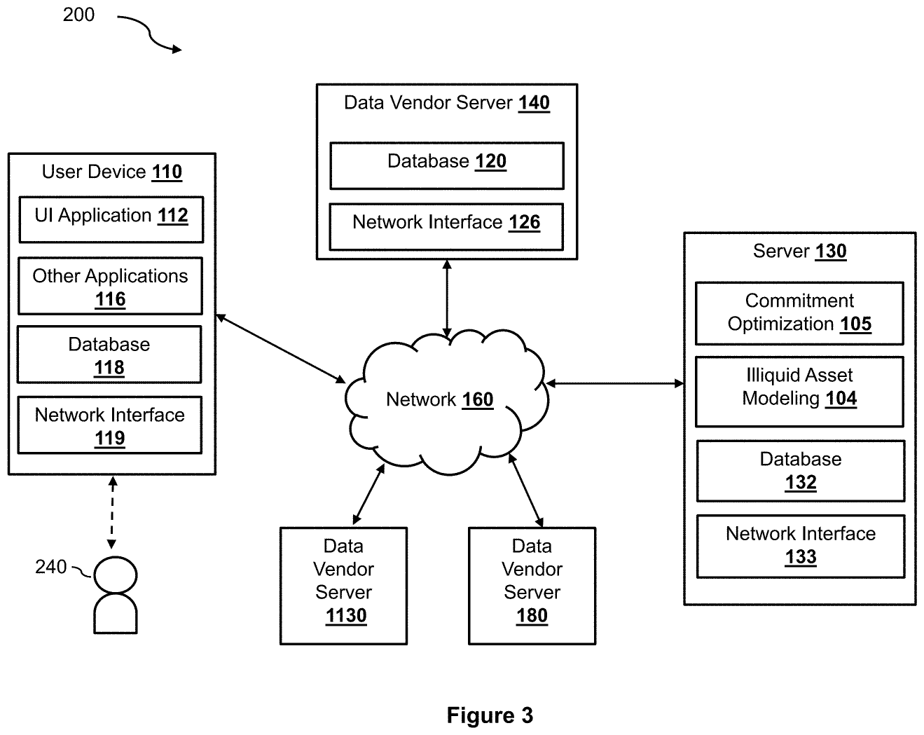

FIG. 3 is a block diagram 200 of a networked system suitable for implementing the processes described in FIG. 2 and other embodiments described herein, according to an embodiment. In one embodiment, block diagram 200 shows a system including the user device 110 which may be operated by user 240, data vendor servers 140, 170 and 180, server 130, and other forms of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 2 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

The user device 110, data vendor servers 140, 170 and 180, and the server 130 may communicate with each other over a network 160. User device 110 may be utilized by a user 240 to access the various features available for user device 110, which may include processes and/or applications associated with the server 130 to receive a commitment plan (e.g., 106 in FIG. 2).

User device 110, data vendor server 140, and the server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 160.

User device 110 may be implemented as a communication device that may utilize appropriate hardware and software configured for wired and/or wireless communication with data vendor server 140 and/or the server 130. For example, in one embodiment, user device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 110 of FIG. 2 contains a user interface (UI) application 112, and/or other applications 116, which may correspond to executable processes, procedures, and/or applications with associated hardware. For example, the user device 110 may receive a data message indicating the commitment plan from the server 130 and display the commitment plan via the UI application 112. In other embodiments, user device 110 may include additional or different modules having specialized hardware and/or software as required.

In various embodiments, user device 110 includes other applications 116 as may be desired in particular embodiments to provide features to user device 110. For example, other applications 116 may include security applications for implementing client-side security features, programmatic client applications for interfacing with appropriate application programming interfaces (APIs) over network 160, or other types of applications. Other applications 116 may also include communication applications, such as email, texting, voice, social networking, and IM applications that allow a user to send and receive emails, calls, texts, and other notifications through network 160. For example, the other application 116 may be an email or instant messaging application that receives a message of the commitment plan from the server 130. Other applications 116 may include device interfaces and other display modules that may receive input and/or output information. For example, other applications 116 may contain software programs, executable by a processor, including a graphical user interface (GUI) configured to provide an interface to the user.

User device 110 may further include database 118 stored in a transitory and/or non-transitory memory of user device 110, which may store various applications and data and be utilized during execution of various modules of user device 110. Database 118 may store received commitment plans, past commitment history, and/or the like. In some embodiments, database 118 may be local to user device 110. However, in other embodiments, database 118 may be external to user device 110 and accessible by user device 110, including cloud storage systems and/or databases that are accessible over network 160.

User device 110 includes at least one network interface component 119 adapted to communicate with data vendor server 140 and/or the server 130. In various embodiments, network interface component 119 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Database 120 (similar to one of the databases 119a-n in FIG. 2) may correspond to a server that hosts the database 120 to provide data records to the server 130. For example, the database 120 may be a financial information database storing information relating to various financial instruments. An illiquid asset transaction record in the database 120, for instance, may include data attributes such as the country of origin, bidding price, bidding history, transaction price, provenance, and/or the like. The database 120 may be implemented by one or more relational database, distributed databases, cloud databases, and/or the like.

The data vendor server 140 includes at least one network interface component 126 adapted to communicate with user device 110 and/or the server 130. In various embodiments, network interface component 126 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 140 may send data records retrieved from the database 120, via the network interface 126, to the server 130.

The server 130 may be housed with the illiquid asset modeling module 104 and the commitment optimization module 105. In some implementations, the modules 104-105 may be a neural network model that is based on hardware, software or a combination thereof.

The database 132 may be stored in a transitory and/or non-transitory memory of the server 130. In various embodiments, for example, the database 132 may be a financial information database storing information relating to various financial instruments. In one implementation, the database 132 may store data records obtained from the data vendor server 140. In some embodiments, database 132 may be local to the server 130. However, in other embodiments, database 132 may be external to the server 130 and accessible by the server 130, including cloud storage systems and/or databases that are accessible over network 160.

The server 130 includes at least one network interface component 133 adapted to communicate with user device 110 and/or data vendor servers 140, 170 or 180 over network 160. In various embodiments, network interface component 133 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 200.

FIG. 4 is a simplified diagram illustrating example aspects of open loop commitment control implemented by the commitment optimization module 104, according to some embodiments described herein. For example, various data parameters, such as a call or distribution rates 303a-n may be obtained based on information from databases 119a-n, respectively. These obtained data parameters may be used to compute illiquid asset mean dynamics parameters, such as mean matrices A,B as defined in Eq. (1).

In one embodiment, the commitment optimization module 105 may determine a plan of commitments based on the mean dynamics, based on the convex optimization problem 340:

$$minimize \frac{1}{T + 1} {\sum }_{t = 1}^{T + 1} {( {\hat{I}}_{t} - {I}^{targ} )}^{2} + {γ}^{smooth} \frac{1}{T - 1} {\sum }_{t = 2}^{T} {( {\hat{n}}_{t} - {\hat{n}}_{t - 1} )}^{2}$$

$$subject to$$

$${\hat{x}}_{t + 1} = A {\hat{x}}_{t} + \overline{B} {\hat{n}}_{t} ,$$

$$t = 1 , … , T$$

$${\hat{x}}_{1} = 0$$

$$0 \leq {\hat{n}}_{t} \leq {n}^{lim} ,$$

$$t = 1 , … , T ,$$

where γ^{smooth}>0 is a hyperparameter that determines the weight of the smoothing penalty. The variables in this problem are \hat{n}₁, . . . , \hat{n}_{T} and \hat{x}₁, . . . , \hat{x}_{T+1} with Îₜ=(xₜ)₁ for t=1, . . . , T+1. The above formulation is a convex optimization problem, a quadratic program (QP), and therefore a convex optimization procedure 345 may be applied to obtain a solution to determine the commitment plan 350 \hat{n}₁, . . . , \hat{n}_{T} and \hat{x}₁, . . . , \hat{x}_{T+1}.

For example, for a set of parameters:

T=20,γ^{smooth}=1,I^{targ}=1,n^{lim}=0.5, (9)

the mean-squared tracking error attained by the commitment plan is 0.133. The tracking error may be computed from t=5 onwards to account for the large contribution to tracking error of the first four periods. Thus, a perhaps more meaningful metric is the delayed root-mean-square (RMS) tracking error:

$${( \frac{1}{T - 4} {\sum }_{t = 5}^{T} ( {I}_{t} - {I}^{targ} ) )}^{1 / 2} .$$

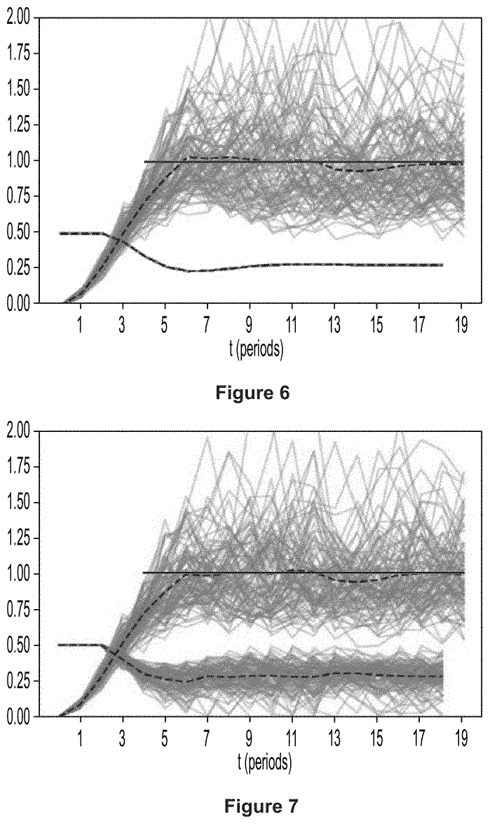

The plan attains a delayed RMS tracking error of 0.071. The optimal commitment sequence hits the limit for the first two periods, in order to quickly bring up the illiquid wealth; then it backs off to a lower level by around period 6, and finally converges to an asymptotic value near I^{targ}/α_{I}=0.27, which is the constant commitment value that would asymptotical give mean illiquid value I^{targ}. FIG. 6 shows the example results by executing the obtained sequence of planned commitments using the open-loop method under random calls and distributions for 100 simulated realizations. The mean-squared tracking error, averaged across the realizations, is 0.199. The delayed root-mean-square tracking error, averaged across the realizations is 0.274.

FIG. 5 is a simplified diagram illustrating example aspects of close loop commitment control implemented by the commitment optimization module 104, according to some embodiments described herein. After obtaining the mean dynamics at 330, model predictive control, which is a closed loop method, meaning nₜ can depend on xₜ, i.e., may be performed, which adapt the commitments to the current values of uncalled commitments and illiquid wealth.

In one embodiment, at every time t=1, . . . , T, commitments over the next H periods t, t+1, . . . , t+H, may be planned, where H is a planning horizon. \hat{x}_{τ|t}, \hat{n}_{τ|t} are used to indicate quantities in the plan at time T from the plan made at time t. These planned quantities are found by solving the optimization problem 348:

$$minimize \frac{1}{H + 1} {\sum }_{𝒯 = 1}^{T + H + 1} {( {\hat{I}}_{𝒯 \vert t} - {I}^{targ} )}^{2} + {γ}^{smooth} \frac{1}{H - 1} {\sum }_{t = 2}^{T} {( {\hat{n}}_{𝒯 \vert t} - {\hat{n}}_{τ - 1 \vert t} )}^{2}$$

$$subject to$$

$${\hat{x}}_{t \vert t} = {x}_{t}$$

$${\hat{x}}_{𝒯 + 1 \vert t} = \overline{A} {\hat{x}}_{𝒯 \vert t} + \overline{B} {\hat{n}}_{𝒯 \vert t} ,$$

$$𝒯 = t , … , t + H$$

$$0 \leq {\hat{n}}_{𝒯 \vert t} \leq {n}^{lim} ,$$

$$𝒯 = t , … , t + H ,$$

with variables \hat{x}_{t|t}, \hat{x}_{t|t+1}, . . . , \hat{x}_{t+H+1|t} and \hat{n}_{t|t}, \hat{n}_{t|t+1}, . . . , \hat{n}_{t+H+1|t}. When the commitment plan is planned at time t, the constraint x_{t|t}=\hat{x}ₜ is included, which closes the feedback loop by planning based on the current realized state.

Therefore, upon obtaining the solution by running a convex optimization procedure 345, at time t, MPC control is executed by nₜ=\hat{n}_{t|t} at 355. Note that the planned quantities Î_{τ|t},\hat{x}_{τ|t}, τ=t+1, . . . , t+H+1, and \hat{n}_{τ|t}, τ=t+1, . . . , t+H, are never executed by the MPC policy.

FIG. 7 shows the example results by executing the obtained sequence of planned commitments using the close-loop method under random calls and distributions for 100 simulated realizations. The average mean-squared error is 0.182. The average delayed root-mean-square tracking error is 0.244, an 11% reduction from the open loop policy.

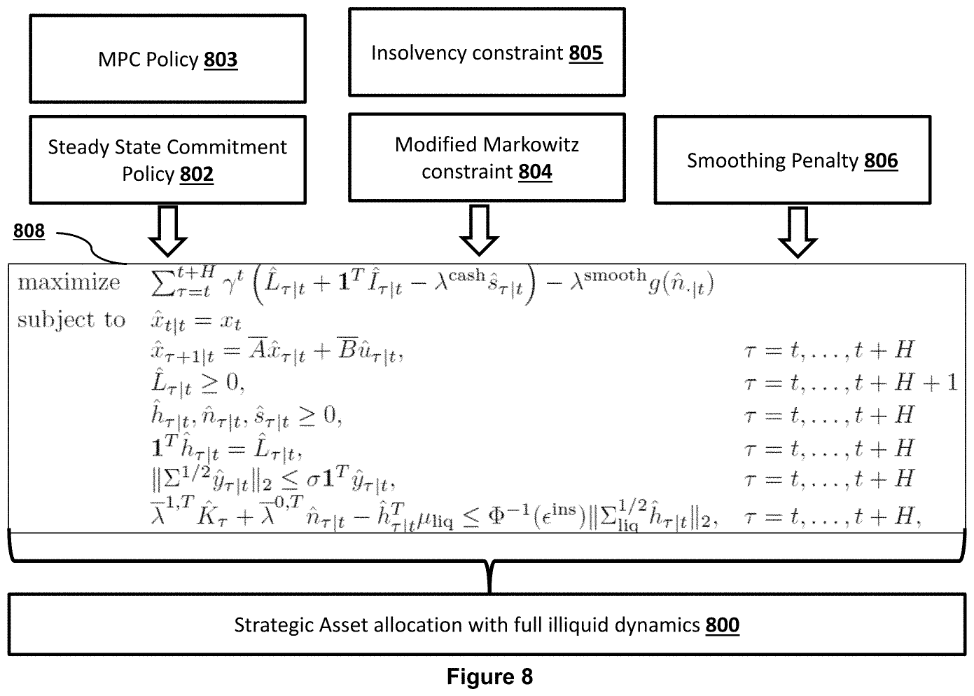

FIG. 8 provides a simplified block diagram illustrating example aspects of strategic asset allocation with full illiquid dynamics as described in relation to FIGS. 4-5, according to embodiment described herein. The strategic asset allocation with full illiquid dynamics 800 may be performed with mixed liquid and illiquid alternative portfolios where we only illiquid position is augmented by making new commitments, and the effect of this action is random and delayed.

For example, the strategic allocation 800 may adopt a steady-state commitment policy 802 which over time establishes and then maintains a given target allocation θ^{targ} under growth is adopted. The method allocates liquid assets proportionate to its desired liquid allocation, and makes new commitments of a target level of illiquid wealth scaled by the asymptotic expected private response to constant commitment. The input is a target allocation θ^{targ} current liquid wealth L and illiquid wealth I. First, the policy checks if L is negative. If it is, it returns control:

u=(h,n,s),h=0,n=0,s=|L|.

Otherwise, if the liquid wealth is positive, the policy proceeds as follows. First, the policy rebalances the liquid holdings proportionately to θ^{targ}:

$$h = L \frac{{θ}^{liq}}{{1}^{T} {θ}^{liq}} ,$$

where θ^{liq}, θ^{ill} are the liquid and illiquid blocks of the allocation vector θ^{targ}=[θ^{liq}, θ^{ill}], respectively. Then, with α_{I} as the 1 dollar private commitment step response and I^{targ} as the target illiquid level, p^{targ}=θ^{ill}(L+1), the policy commits

$${n}_{i} = \frac{{I}_{i}^{targ}}{{α I}_{i}}$$

and returns control u=(h, n, 0).

In another embodiment, the strategic allocation 800 may adopt an MPC policy 803 which plans ahead based on a model of the future, seeking to maximize wealth subject to various risk constraints. For a sequence of prospective actions, the policy forecasts future state variables using the mean dynamics described in Eq. (11). The policy then chooses a sequence of actions by optimizing an objective which depends on the planned actions and forecast states. Finally, the policy executes solely the first step of the planned sequence. The impact of that action is observed, and the resulting state is observed, and then this cycle repeats. The policy selects a planned sequence of actions by trying to maximize the ultimate total liquid and illiquid wealth. However, it is also constrained by a user's risk tolerance, which caps the allowable per period return volatility. Additionally, because capital calls are stochastic in nature, the policy seeks to guarantee that with high probability, all capital calls can be funded from the liquid wealth.

In one embodiment, the strategic asset allocation 800 may adopt a risk constraint 804 in the planning problem. However, the Markowitz problem has variables in weight space rather than wealth space. Other multi-period optimization problems based on the Markowitz problem, e.g., assuming a timescale over which the wealth does not grow significantly over the planning horizon. As potential application contexts include endowments and insurers, substantial growth may be handled over the investment horizon. Thus, an analogous risk constraint in wealth space rather than weight space may be considered:

$$\frac{{y}^{T} Σ y}{{( {1}^{T} y )}^{2}} \leq {σ}^{2} ⇔ {‖ {Σ}^{1 / 2} y ‖}_{2} \leq {σ1}^{T} y .$$

y=(h, I) is the liquid and illiquid exposure. Thus, the constraint

∥Σ^{1/2}y∥₂≤σ1^{T}y,

which is invariant in wealth. It is also convex, which means that problems with such constraints can be reliably solved.

In one embodiment, the strategic asset allocation 800 may further adopt an insolvency constraint 805. An important challenge in performing strategic asset allocation with illiquid alternatives is ensuring that the probability of being unable to pay a capital call is extremely low. This corresponds to requiring:

P(Wₜ₊₁<0|Xₜ,nₜ,hₜ)≤ϵ^{ins}

for a small probability of failure ϵ^{ins}. Several approximations are conducted to facilitate a convex constraint. First, Rₜ^{liq} is approximated as a multivariate normal random variable:

Rₜ^{liq}˜N(μ_{liq},Σ_{liq}).

It is important to note that these parameters are the mean and covariance of the liquid returns, rather than the mean and covariance which parameterize the log normal liquid return distribution given by μᵣₑₜ and Σᵣₑₜ in Eq. (12). Then it is assumed the expected calls are:

c̅ₜ=E[Cₜ|Xₜ,nₜ,hₜ],

which is a linear function of the commitment controls. They are given by:

c̅ₜ=λ̅ₜ^{1,T}Kₜ+λ̅ₜ^{0,T}nₜ.

Finally, it is assumed that there are no distributions or outside cash. With these approximations, the constraint may be computed as:

$$P ( {W}_{t + 1} < 0 \vert {X}_{t} , {n}_{t} , {h}_{l} ) \approx P ( {R}_{t}^{liq} {h}_{t} - {\overline{c}}_{t} \leq 0 ) = P ( N ( {h}_{t}^{T} {μ}_{liq} - {\overline{c}}_{t} , {h}_{t}^{T} {Σ}_{liq} {h}_{t} ) < 0 ) \leq ϵ .$$

This probabilistic constraint holds if and only if

c̅ₜ=hₜ^{T}μ_{liq}≤Φ⁻¹(ϵ^{ins})∥Σ_{liq}^{1/2}hₜ∥₂, (17)

where Φ is the standard normal cumulative distribution function. This constraint is convex provided ϵ^{ins}≤½, as then Φ⁻¹(ϵ^{ins})≤0, and (17) is a second order cone constraint. As mentioned above, the constraint (17) is pessimistic because it assumes no distribution. An alternative and less pessimistic formulation of the insolvency constraint would consider the distribution, the calls, and the liquid returns all under a joint normal approximation.

In one embodiment, the strategic asset allocation 800 may further adopt a smoothing penalty 806. Among control sequences with similar objective values, new commitments to be fairly smooth across time, and thus a natural commitment smoothing penalty may be considered:

$$g ( n ) = {\sum }_{t = 0}^{H - 1} {γ}^{t} {‖ {n}_{t + 1} - {n}_{t} ‖}^{2}$$

The time discount appears because in a growth context we expect nₜ to increase over time. Additionally, it helps account for the increased uncertainty of future planned steps.

Therefore, the above discussed objective terms and constraints outlined above are consolidated into an MPC optimization problem 808. At time t, state \hat{x}_{t|t}, \hat{x}_{t|t+1}, . . . , x_{t+H+1|t} and control û_{t|t}, û_{t|t+1}, . . . , u_{t+H+1|t}, where H is the planning horizon, are obtained by solving the optimization problem using a convex optimization procedure:

$$maximize {\sum }_{𝒯 = i}^{t + H} {γ}^{t} ( {\hat{L}}_{𝒯 \vert t} + {1}^{T} {\hat{I}}_{𝒯 \vert t} - {λ}^{cash} {\hat{s}}_{𝒯 \vert t} ) - {λ}^{smooth} y ( {\hat{n}}_{𝒯 \vert t} ) \qquad ( 18 )$$

$$subject to$$

$${\hat{x}}_{t \vert t} = {x}_{t}$$

$$𝒯 = t , … , t + H$$

$${\hat{x}}_{𝒯 + 1 \vert t} = \overline{A} {\hat{x}}_{𝒯 \vert t} + \overline{B} {\hat{u}}_{𝒯 \vert t} ,$$

$$𝒯 = t , … , t + H + 1$$

$${\hat{L}}_{𝒯 \vert t} \geq 0 ,$$

$${\hat{L}}_{𝒯 \vert t}$$

$$𝒯 = t , … , t + H$$

$${\hat{h}}_{𝒯 \vert t} , {\hat{n}}_{𝒯 \vert t} , {\hat{s}}_{𝒯 \vert t} \geq 0 ,$$

$$𝒯 = t , … , t + H$$

$${1}^{T} {\hat{h}}_{𝒯 \vert t} = {\hat{L}}_{𝒯 \vert t} ,$$

$$𝒯 = t , … , t + H$$

$${‖ {Σ}^{1 / 2} {\hat{y}}_{𝒯 \vert t} ‖}_{2} \leq {σ1}^{T} {\hat{y}}_{𝒯 \vert t} ,$$

$$𝒯 = t , … , t + H$$

$${\overline{λ}}^{1 , T} {\hat{K}}_{𝒯} + {\overline{λ}}^{0 , T} {\hat{n}}_{𝒯 \vert t} - {\hat{h}}_{𝒯 \vert t}^{T} {μ}_{liq} \leq {Φ}^{- 1} ( {ϵ}^{ins} ) {‖ {Σ}_{liq}^{1 / 2} {\hat{h}}_{𝒯 \vert t} ‖}_{2} ,$$

$$𝒯 = t , … , t + H .$$

where λ^{cash}>0 is a hyperparameter penalizing outside cash use. Recall that L, I, and K are components of x, and h, n, and s are components of u.

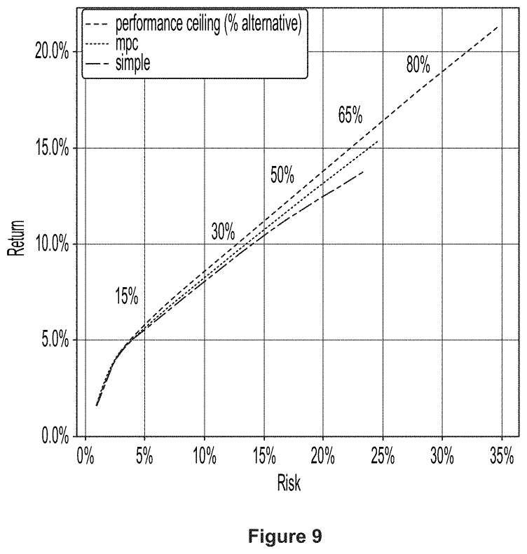

FIG. 9 is an example risk-return trade-off plot for the strategic asset allocation 800 shown in FIG. 8. Example parameters may be set as:

$${μ}_{ret} = ( 0.158 , 0. , 0.072 , 0.023 , 0.036 , 0.046 ) , \qquad ( 19 )$$

$${σ}_{ret} = ( 0.281 , 0. , 0.206 , 0.046 , 0.047 , 0.162 ) , \qquad ( 20 )$$

$${C}_{ret} = [ \begin{matrix}1. & 0. & 0.422 & - 0.298 & - 0.002 & 0.261 \\ 0. & 1. & 0. & 0. & 0. & 0. \\ 0.422 & 0. & 1. & - 0.843 & 0.197 & 0.8 \\ - 0.298 & 0. & - 0.843 & 1. & - 0.018 & - 0.739 \\ - 0.002 & 0. & 0.197 & - 0.018 & 1. & 0.628 \\ 0.261 & 0. & 0.8 & - 0.739 & 0.628 & 1.\end{matrix} ] \qquad ( 21 )$$

with Σᵣₑₜ=diag(σᵣₑₜ)C diag(σᵣₑₜ).

Specifically, the steady state commitment policy 802 is implemented with parameters c=3.685, k=0.1, and values of 0 arising from solving the one period Markowitz problem for 30 evenly spaced values of a between 0 and 0.3, with specified return distribution parameters. For the MPC policy 803, the same σ values described above is adopted, but for numerical reasons use the standard trick of moving the risk limit to penalized form by subtracting

λ^{risk}(∥Σ^{1/2}yₜ∥₂−σ1^{T}yₜ)₊

from each term of the objective defined in (18), penalizing excess risk. The parameter values are:

γ=0.97,H=10,ϵ^{ins}=0.02,λ^{risk}=10,λ^{smooth}=0.1,λ^{cash}=1000,

with the system mean matrices defined in Eq. (11).

As shown in FIG. 9, both the MPC and heuristic policies are extremely close to the risk-return performance of the liquid relaxation, which is an unattainable benchmark. This is despite the challenging illiquid dynamics we face in the non-relaxed setting. The performance stated here is averaged across 20 periods of simulation, for 200 simulated trajectories.

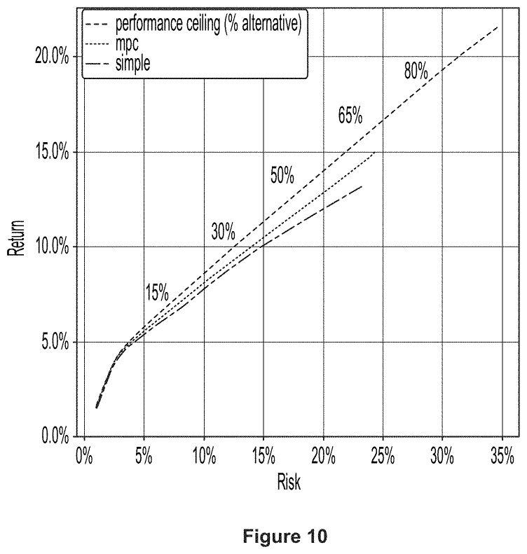

The performance across a shorter time horizon is further shown in FIG. 10 showing the same risk-return tradeoff for 10 periods. Evidently, there is a larger gap between the MPC policy and the liquid performance ceiling, and also between the MPC and simple policies. This has a perfectly clear interpretation: because there is a roughly 4 period delay before peak illiquid exposure, the impact of the illiquid alternative asset's high returns is delayed. Additionally, by planning ahead, the MPC policy achieves illiquid exposure faster than the simple policy.

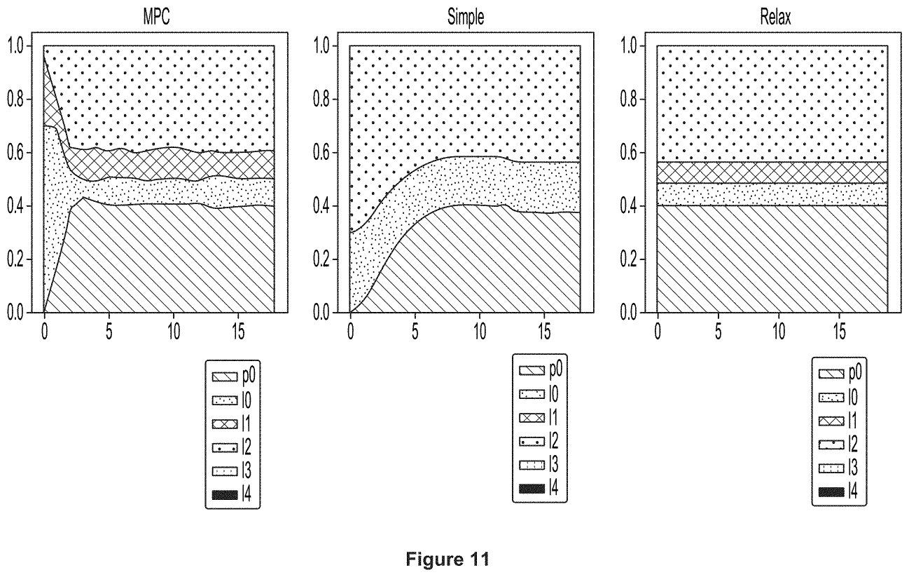

By looking at the average allocation across time for both policies shown in FIG. 11, these differences are further shown. The MPC policy is able to reach a stable allocation in fewer periods than the heuristic policy. If the proportional feedback control is included, the heuristic does reach the allocation faster, but still not as quickly as the MPC. Another difference is that the heuristic policy and MPC sweep out the same risk return tradeoff, but may not choose the exact same portfolio steady state weights. Generally, the heuristic undershoots the illiquid target it is trying to reach.

In further embodiments, the model dynamics described in FIGS. 1-8 may be further extended. For example, to allow for liquidation of illiquid alternatives on the secondaries market. For instance, it is assumed that at time t, 0≤lₜ≤Pt which, after a haircut Φ is available as liquid wealth ϕlₜ. This changes the control by appending an lₜ∈Rⁿ^{^{ill}} to uₜ Accordingly, the new control matrix is given by:

[Bₜ^{liq}\check{B}t],

with

$${\hat{B}}_{t} = [ \begin{matrix}{ϕ1}^{T} \\ - I \\ 0\end{matrix} ] ,$$

where the block of zeros and the identify matrix are in the dimension of Rⁿ^{^{ill}}^{×n}^{^{ill}}.

In another embodiment, the model dynamics described in FIGS. 1-8 may be extended to tracking fixed weights. A user may specify a risk tolerance parameter a as in Eq. (13), which implicitly specifies the portfolio weights across the liquid and illiquid assets. However, an investor may have arrived with pre-selected target portfolio weights. Instead of seeking to track a target illiquid exposure, target portfolio weights may be tracked. A natural tracking constraint in planning is:

∥Σ^{1/2}(ŷ_{τ|t}−θ1^{T}ŷ_{τ|t})∥₂≤σ^{track}1^{T}ŷ_{τ|t},

where θ is the user-provided vector of target portfolio weights, and σ^{track} is a tracking variance hyperparameter. As with the risk constraint in Eq. (18), in practice a slack variable can be added to the above constraint to guarantee feasibility.

In another embodiment, external liabilities Zₜ may be incorporated for modifying our liquid wealth update to:

Lₜ₊₁=hₜ^{T}Rₜ^{liq}−1^{T}Cₜ+1^{T}Dₜ+sₜ−Zₜ.

This encodes an external obligation of Zₜ dollars in period t. This could represent the liabilities of an insurer or a pension fund. MPC is able to handle these liabilities quite gracefully: at every time t the planning problem takes in a forecast of the next H liabilities and then the insolvency constraint Eq. (17) can be modified as:

Lₜ+c̅ₜ−hₜ^{T}μ_{liq}≤Φ⁻¹(ϵ^{ins})∥Σ_{liq}^{1/2}h_{T}∥₂.

In another embodiment, illiquid dynamics with vintages may be considered, e.g., time varying intensity parameters that depend on the age of the investment. This amounts to keeping track of vintages for each asset class, rather than aggregating all exposure to a given illiquid asset in one state. This extension is readily implementable as an only slightly larger tractable convex optimization-based planning problem. A given illiquid asset at time t, rather than by two states It and Kt, will now require 2k states, I_{t,a} and K_{t,a}, where a denotes the age of the investment and the maximum age tracked is k. In words, at each time, the strategic asset allocation 800 keeps track of the exposure and uncalled commitments from commitments of age a.

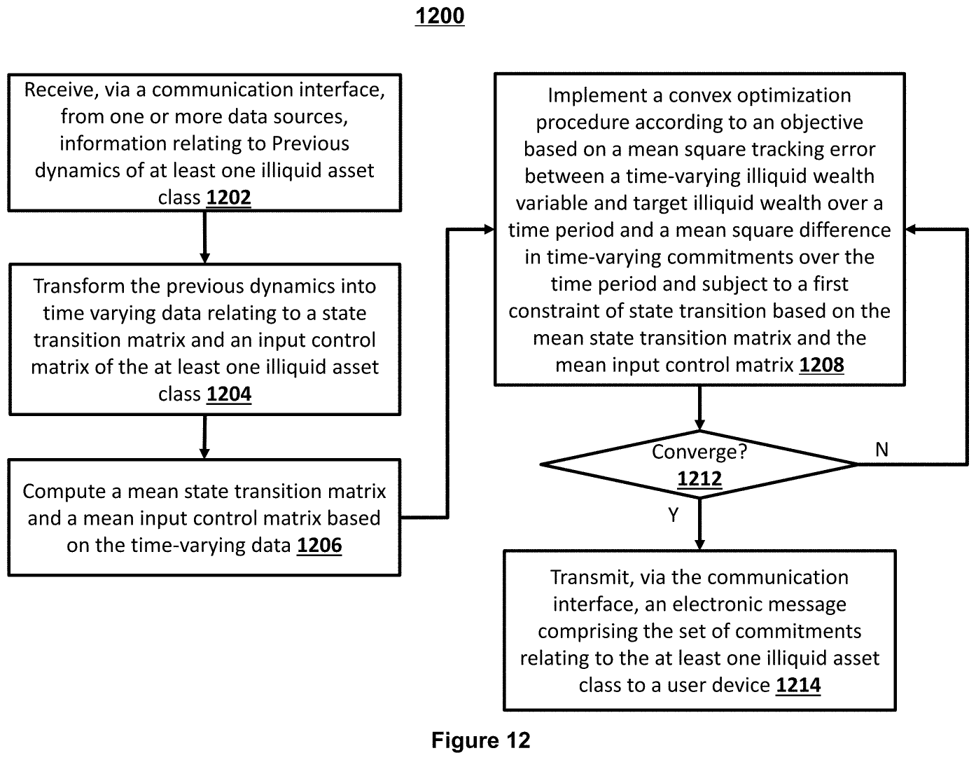

FIG. 12 is an example logic flow diagram illustrating a method 1200 of generating a commitment plan for a portfolio comprising at least one illiquid asset class shown in FIGS. 1-11, according to some embodiments described herein. One or more of the processes of method 1200 may be implemented, at least in part, in the form of executable code stored on non-transitory, tangible, machine-readable media that when run by one or more processors may cause the one or more processors to perform one or more of the processes. In some embodiments, method 1200 corresponds to the operation of the modules 104-105 (e.g., FIGS. 1-2) that performs generating commitment plans for illiquid asset classes.

As illustrated, the method 1200 includes a number of enumerated steps, but aspects of the method 1200 may include additional steps before, after, and in between the enumerated steps. In some aspects, one or more of the enumerated steps may be omitted or performed in a different order.

At step 1202, a communication interface (e.g., network interface 133 in FIG. 3) may receive, from one or more data sources (e.g., databases 119a-n in FIG. 2, or data vendor servers 140, 170 and 180 in FIG. 3), information relating to previous dynamics of at least one illiquid asset class. For example, such information may include previous dynamics of the illiquid asset class, which takes a form of time series data indicating a capital call event (e.g., 101a in FIG. 1) at a first time, a distribution event (e.g., 101b in FIG. 1) at a second time, a commitment event (e.g., 101c in FIG. 1) at a third time over a sequence of discrete time steps. Such time series data reflects the trends and patterns of activities relating to the illiquid asset class over time.

At step 1204, the previous dynamics may be transformed into time varying data relating to a state transition matrix and an input control matrix of the at least one illiquid asset class. For example, the time series data indicating various random events that previously happened with the illiquid asset data may be analyzed using statistical methods, such as autoregression, moving averages, and exponential smoothing, or machine learning techniques, such as recurrent neural networks and decision trees.

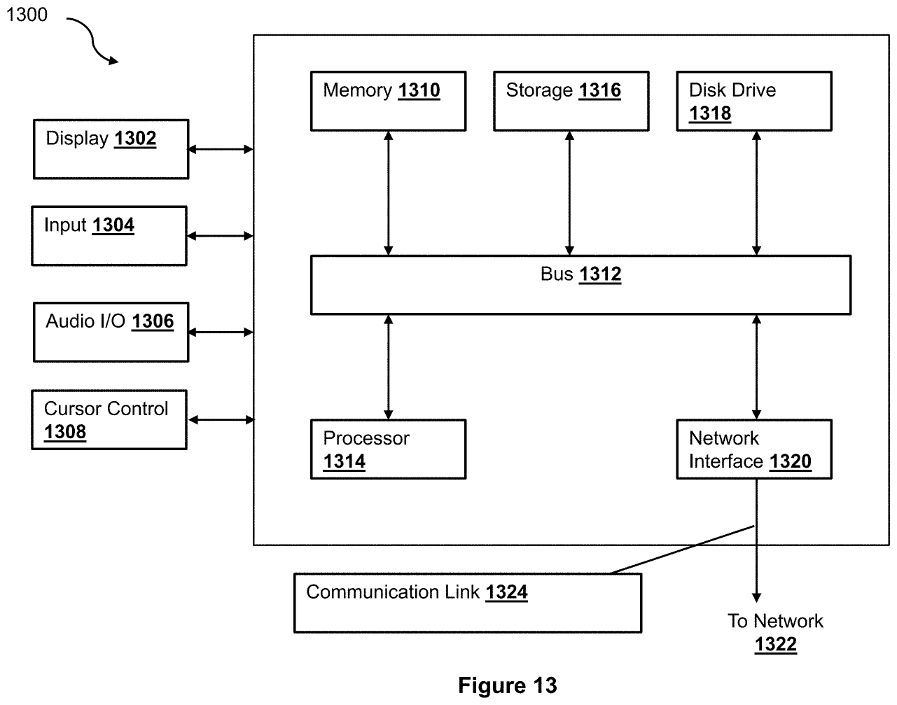

A random immediate commitment call intensity, a random existing commitment call intensity, a random distribution intensity that are independent and identically distributed random variables over time may be formulated based on the statistical analysis. In one implementation, the computed random variables may be transformed into the state transition matrix and the input control matrix, e.g., Eq. (1). The generated state transition matrix and the input control matrix over time may then be stored at a memory (e.g., 1310 in FIG. 13).

At step 1206, a mean state transition matrix and a mean input control matrix based on the time-varying data. For example, system mean matrices may be computed by taking an expectation of the time-varying matrices such that the mean matrices no longer depend on the time t. In some implementations, the mean matrices may be stationary mean dynamics generated at a first time, or time-varying forecasted mean dynamics at a second time conditioned at a first time.

In this way, the input time series data indicating previous dynamics of an illiquid asset class, which is in the form of a sequence of data points, is converted into system matrices that reflect the transition and control properties of the illiquid asset class.

At step 1208, a convex optimization procedure may be implemented according to an objective based on a mean square tracking error between a time-varying illiquid wealth variable and target illiquid wealth over a time period and a mean square difference in time-varying commitments over the time period and subject to a first constraint of state transition based on the mean state transition matrix and the mean input control matrix. Specifically, the convex optimization procedure, such as, but not limited to gradient descent and interior-point methods, may be implemented iteratively until a set of commitments is achieved that minimizes the objective subject to the first constraint.

For example, in one implementation, the objective may be computed as the open-loop commitment control objective (e.g., see 340 in FIG. 4). In this case, the determined set of commitments is a fixed sequence of commitments over time.

For another example, in one implementation, the objective may be computed as a closed-loop commitment control objective (e.g., see 348 in FIG. 5), and the set of commitments are adapted commitments based on previously realized returns, capital calls and distributions. Specifically, a respective set of commitments starting from the respective time step over a future time period t+H may be determined through the convex optimization at each time step t. Then, a commitment corresponding to the respective time step t from the respective set of commitments may be executed at time t, while remaining planned commitments from time t+1 to t+H in the respective set of commitments are discarded.

At step 1212, method 1200 may continue to repeat step 1208 when the convex optimization procedure does not converge. Otherwise, method 1200 may end the iteration and proceeds to step 1214. For example, the convex optimization procedure may, at each iteration, adjust the variables (such as the commitment plans or their dual variables) in the direction of the negative gradient of the objective function. The negative gradient points in the direction of steepest descent, and the algorithm moves the variables in that direction, taking a step size determined by a learning rate parameter. When the updated objective function based on the currently updated commitment plan variables reaches its minimum, or within a desired level of accuracy, the iterations may stop and the current values of the variables are returned as the solution of the convex optimization procedure.

At step 1214, the communication interface may transmit an electronic message comprising the set of commitments relating to the at least one illiquid asset class to a user device. For example, the electronic message may include any of an electronic mail, an instant message, a push message, a multimedia message, and/or the like. In some implementations, given the generated set of commitment plans, a transaction request or a recommendation for transaction request may be generated and transmitted to a financial platform for the execution of the commitment.

FIG. 13 is a block diagram of a computer system 1300 suitable for implementing one or more components shown in FIGS. 1-12 and performing one or more processes described herein, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 1300 in a manner as follows.

The computer system 1300 includes a bus 1312 or other communication mechanism for communicating information data, signals, and information between various components of the computer system 1300. The components include an input/output (I/O) component 1304 that processes a user (i.e., sender, recipient, service provider) action, such as selecting keys from a keypad/keyboard, selecting one or more buttons or links, etc., and sends a corresponding signal to the bus 1312. The I/O component 1304 may also include an output component, such as a display 1302 and a cursor control 1308 (such as a keyboard, keypad, mouse, etc.). The display 1302 may be configured to present a login page for logging into a user account or a checkout page for purchasing an item from a merchant. An optional audio input/output component 1306 may also be included to allow a user to use voice for inputting information by converting audio signals. The audio I/O component 1306 may allow the user to hear audio. A transceiver or network interface 1320 transmits and receives signals between the computer system 1300 and other devices, such as another user device, a merchant server, or a service provider server via network 1322. In one embodiment, the transmission is wireless, although other transmission mediums and methods may also be suitable. A processor 1314, which can be a micro-controller, digital signal processor (DSP), or other processing component, processes these various signals, such as for display on the computer system 1300 or transmission to other devices via a communication link 1324. The processor 1314 may also control transmission of information, such as cookies or IP addresses, to other devices.

The components of the computer system 1300 also include a system memory component 1310 (e.g., RAM), a static storage component 1316 (e.g., ROM), and/or a disk drive 1318 (e.g., a solid-state drive, a hard drive). The computer system 1300 performs specific operations by the processor 1314 and other components by executing one or more sequences of instructions contained in the system memory component 1310. For example, the processor 1314 can perform the position detection of webpage elements described herein according to the process 300.

Logic may be encoded in a computer readable medium, which may refer to any medium that participates in providing instructions to the processor 1314 for execution. Such a medium may take many forms, including but not limited to, non-volatile media, volatile media, and transmission media. In various implementations, non-volatile media includes optical or magnetic disks, volatile media includes dynamic memory, such as the system memory component 1310, and transmission media includes coaxial cables, copper wire, and fiber optics, including wires that comprise the bus 1312. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 1300. In various other embodiments of the present disclosure, a plurality of computer systems 1300 coupled by the communication link 1324 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications.

What is claimed is:

1. A method for generating a commitment plan for a portfolio comprising at least one illiquid asset class, the method comprising:
receiving, via a communication interface, from one or more data sources, information relating to previous dynamics of at least one illiquid asset class;
transforming the previous dynamics into time varying data relating to a state transition matrix and an input control matrix of the at least one illiquid asset class;
computing, by a processor, a mean state transition matrix and a mean input control matrix based on the time-varying data;
implementing, by the processor, a convex optimization procedure according to an objective based on a mean square tracking error between a time-varying illiquid wealth variable and target illiquid wealth over a time period and a mean square difference in time-varying commitments over the time period and subject to a first constraint of state transition based on the mean state transition matrix and the mean input control matrix,
wherein the convex optimization procedure is implemented iteratively until a set of commitments is achieved that minimizes the objective subject to the first constraint; and
transmitting, via the communication interface, an electronic message comprising the set of commitments relating to the at least one illiquid asset class to a user device.

2. The method of claim 1, wherein the previous dynamics include time series data indicating a capital call event at a first time, a distribution event at a second time, a commitment event at a third time.

3. The method of claim 1, wherein the time-varying data includes a random immediate commitment call intensity, a random existing commitment call intensity, a random distribution intensity that are independent and identically distributed random variables over time, and
wherein the state transition matrix and the input control matrix are composed of entries based on the random variables.

4. The method of claim 1, wherein the objective is computed as an open-loop commitment control objective and the set of commitments is a fixed sequence of commitments over time.

5. The method of claim 1, wherein the objective is computed as a closed-loop commitment control objective, and the set of commitments are adapted commitments based on previously realized returns, capital calls and distributions.

6. The method of claim 5, further comprising:
determining, at each time step, a respective set of commitments starting from the respective time step over a future time period; and
executing, at a respective timestep, a commitment corresponding to the respective time step, from the respective set of commitments and wherein a commitment at a current time while discarding remaining planned commitments in the respective set of commitments.

7. The method of claim 1, wherein the portfolio comprises multiple illiquid asset classes and liquid asset classes, and wherein the receiving comprises receiving information relating to previous dynamics of the multiple illiquid asset classes and liquid asset classes.

8. The method of claim 1, wherein the mean state transition matrix or the mean input control matrix are computed as at least one of:
stationary mean dynamics generated at a first time; or
time-varying forecasted mean dynamics at a second time conditioned at a first time.

9. The method of claim 1, wherein the convex optimization procedure is further subject to a second constraint based on a risk tolerance parameter and a liquid and illiquid exposure of the portfolio.

10. The method of claim 1, wherein the convex optimization procedure is further subject to a second constraint based on a probability of insolvency.

11. A system for generating a commitment plan for a portfolio comprising at least one illiquid asset class, the system comprising:
a communication interface that receives, from one or more data sources, information relating to previous dynamics of the at least one illiquid asset class;
a memory storing a plurality of processor-executed instructions; and
one or more processors executing the plurality of processor-executed instructions to perform operations comprising:
transforming the previous dynamics into time varying data relating to a state transition matrix and an input control matrix of the at least one illiquid asset class;
computing a mean state transition matrix and a mean input control matrix based on the time-varying data;
implementing a convex optimization procedure according to an objective based on a mean square tracking error between a time-varying illiquid wealth variable and target illiquid wealth over a time period and a mean square difference in time-varying commitments over the time period and subject to a first constraint of state transition based on the mean state transition matrix and the mean input control matrix,
wherein the convex optimization procedure is implemented iteratively until a set of commitments is achieved that minimizes the objective subject to the first constraint; and
generating the commitment plan based on the set of commitments,
wherein the communication interface transmits a transaction request message, to a financial exchange platform, according to the set of commitments relating to the at least one illiquid asset class.

12. The system of claim 11, wherein the previous dynamics include time series data indicating a capital call event at a first time, a distribution event at a second time, a commitment event at a third time.

13. The system of claim 11, wherein the time-varying data includes a random immediate commitment call intensity, a random existing commitment call intensity, a random distribution intensity that are independent and identically distributed random variables over time, and
wherein the state transition matrix and the input control matrix are composed of entries based on the random variables.

14. The system of claim 11, wherein the objective is computed as an open-loop commitment control objective and the set of commitments is a fixed sequence of commitments over time.

15. The system of claim 11, wherein the objective is computed as a closed-loop commitment control objective, and the set of commitments are adapted commitments based on previously realized returns, capital calls and distributions.

16. The system of claim 15, wherein the operations further comprise:
determining, at each time step, a respective set of commitments starting from the respective time step over a future time period; and
executing, at a respective timestep, a commitment corresponding to the respective time step, from the respective set of commitments and wherein a commitment at a current time while discarding remaining planned commitments in the respective set of commitments.

17. The system of claim 11, wherein the portfolio comprises multiple illiquid asset classes and liquid asset classes, and wherein the receiving comprises receiving information relating to previous dynamics of the multiple illiquid asset classes and liquid asset classes.

18. The system of claim 11, wherein the mean state transition matrix or the mean input control matrix are computed as at least one of:
stationary mean dynamics generated at a first time; or
time-varying forecasted mean dynamics at a second time conditioned at a first time.

19. The system of claim 11, wherein the convex optimization procedure is further subject to a second constraint based on a risk tolerance parameter and a liquid and illiquid exposure of the portfolio, and/or a third second constraint based on a probability of insolvency.

20. A non-transitory processor-readable medium storing a plurality of processor-executable instructions for generating a commitment plan for a portfolio comprising at least one illiquid asset class, the instructions being executed by one or more processors to perform operations comprising:
receiving, via a communication interface, from one or more data sources, information relating to previous dynamics of the at least one illiquid asset class;
transforming the previous dynamics into time varying data relating to a state transition matrix and an input control matrix of the at least one illiquid asset class;
computing a mean state transition matrix and a mean input control matrix based on the time-varying data;
implementing a convex optimization procedure according to an objective based on a mean square tracking error between a time-varying illiquid wealth variable and target illiquid wealth over a time period and a mean square difference in time-varying commitments over the time period and subject to a first constraint of state transition based on the mean state transition matrix and the mean input control matrix,
wherein the convex optimization procedure is implemented iteratively until a set of commitments is achieved that minimizes the objective subject to the first constraint; and
transmitting, via the communication interface, an electronic message comprising the set of commitments relating to the at least one illiquid asset class to a user device.
